(19) United States
(12) Patent Application Publication
(10) Pub. No.: US 2016/0243490 A1
(43) Pub. Date: Aug. 25, 2016

(54) PROCESS FOR CAPTURING CO2 FROM A CO2-CONTAINING GAS STREAM INVOLVING PHASE SEPARATION OF AQUEOUS ABSORBENT

(71) Applicant: CARBONORO B.V., Nijmegen (NL)

(72) Inventors: Matheus Theodorus DE GROOT, Utrecht (NL); Johannes Petrus Aldegonda CUSTERS, Baexem (NL); Antoon Jacob Berend TEN KATE, Arnhem (NL); Dirk Theodorus Andreas VAN ASSELDONK, Veghel (NL); Johannes Theodorus Faustinus KEURENTJES, Helmond (NL)

(73) Assignee: CarbonOrO B.V., Nijmegen, (NL)

(21) Appl. No.: 15/027,649

(22) PCT Filed: Oct. 6, 2014
(86) PCT No.: PCT/NL2014/050690

§ 371 Date: Apr. 6, 2016

(30) Foreign Application Priority Data
Oct. 7, 2013 (EP) 13187524.7

(51) Int. Cl. B01D 53/14

(52) U.S. Cl. CPC B01D 53/1425; B01D 53/1475; B01D 53/1493; B01D 2252/204; B01D 2252/504

(57) ABSTRACT

The present invention relates to a process for capturing CO₂ from a CO₂—containing gas stream, comprising the steps of: (a) contacting a CO₂-containing gas stream with a CO₂-absorbing agent in an absorption step wherein the temperature of the CO₂ absorbing agent at the end of the absorption step is below the LCST of the CO₂-absorbing agent at the end of the absorption step, resulting in absorption of CO₂; (b) increasing the temperature of the CO₂-absorbing agent, wherein the temperature at the end of the desorption step is above the LCST of the CO₂-absorbing agent at the end of the desorption step, resulting in the desorption of CO₂; wherein the CO₂-absorbing agent is a thermoresponsive CO₂-absorbing agent comprising an amine-containing component, a solute inorganic salt, and water.

### FIELD OF THE INVENTION

The present invention pertains to a process for capturing CO₂ from a CO₂ containing gas stream. CO₂ is produced as side product in many chemical processes, e.g. from combustion of organic materials in power plants. Release of CO₂ into the atmosphere is undesirable in view of its contribution to the greenhouse effect. Further, CO₂ itself can be used as starting material for chemical reactions. There is therefore need for a method for capturing CO₂ from a CO₂ containing gas stream, which is not only effective in capturing CO₂, but which also allows release of the CO₂ to allow it to be processed further.

### BACKGROUND OF THE INVENTION

Methods for capturing CO₂ from a CO₂-containing gas stream are known in the art. The most commonly applied method is post combustion CO₂ capture, which is generally carried out in the following way: a CO₂ containing gas stream coming from, e.g., a coal fired power plant is contacted in an absorption column with an amine containing aqueous liquid at a temperature of about 40° C., which results in absorption of the CO₂. A commonly used amine is monoethanolamine (MEA). The CO₂-containing liquid stream is subsequently brought to a desorption column, which is operated at elevated temperature (>100° C.). In this column the CO₂ is desorbed, after which it is compressed and ready for further use. The depleted liquid is returned to the absorption column. A weakness of this process is the relatively high energy consumption of the process. This high energy consumption is a result of the relatively high temperature needed in the desorption column to obtain sufficient CO₂ desorption.

There have been many investigations into CO₂ capture processes with lower energy consumption. One particularly interesting idea concerns the use of a phase separation to enhance the desorption of CO₂ in such a way that it occurs at lower temperatures. For example, US2010/0288126, incorporated by reference, discloses a process wherein a CO₂-containing gas stream is contacted with a CO₂-absorbing agent, followed by at least partial removal of the CO₂ absorbing agent and inducing a phase separation accompanied by the release of CO₂. US2010/0104490, incorporated by reference, discloses an integrated process using such phase separation steps.

While the system described in these references is attractive in principle, it suffers from various disadvantages. In particular, it has been found that the net CO₂ sorption of the process may be improved. The quantity of CO₂ absorbed can be expressed in the loading a, which is defined as follows:

$$α = \frac{moles {CO}_{2} absorbed}{moles amines present}$$

The net CO₂ sorption, αₙₑₜ, in the process can be defined as the difference in α at the end of the absorption step (α_{absorption}) and at the end of the desorption step (α_{desorption}):

αₙₑₜ=α_{absorption}−α_{desorption}

Further, it would be desirable if the system could be regenerated at a lower temperature.

The present invention provides a solution to this problem. Additional advantages of the present invention will become clear from the further specification. US 2006/104877 and US 2009/199709, both incorporated by reference, disclose a process for deacidising a gas stream, wherein the gas stream is contacted with an absorbent solution. The absorbent solution comprises an activator, e.g. an amine, and an additional compound, for example a salt.

US 2013/118350, incorporated by reference, discloses a process for separating acid gases from a gas mixture in which the gas mixture is contacted with an absorption medium which comprises water and at least one amine and has a phase-separation temperature in the range from 0 to 130° C.

### SUMMARY OF THE INVENTION

The present invention pertains to a process for capturing CO₂ from a CO₂-containing gas stream, comprising the steps of:
(a) contacting a CO₂-containing gas stream with a CO₂-absorbing agent in an absorption step wherein the temperature of the CO₂ absorbing agent at the end of the absorption step is below the LCST of the CO₂-absorbing agent at the end of the absorption step, resulting in absorption of CO₂,
(b) increasing the temperature of the CO₂-absorbing agent, wherein the temperature at the end of the desorption step is above the LCST of the CO₂-absorbing agent at the end of the desorption step, resulting in the desorption of CO₂,
   wherein the CO₂-absorbing agent is a thermoresponsive CO-absorbing agent comprising an amine-containing component, a solute inorganic salt, and water.

### BRIEF DESCRIPTION OF THE DRAWINGS

FIG. 1 shows a schematic diagram of an embodiment of the process according to the invention.

FIG. 2 shows a schematic representation of the reactors used in Example 1.

FIG. 3 shows vapour/liquid equilibrium data for CO₂ in equilibrium with 3 different CO₂ absorbing agents at temperatures of 40 and 80° C. and 1 bar pressure (Example 1).

### DETAILED DESCRIPTION OF THE INVENTION

The verb “to comprise” and its conjugations as used in this description and in the claims are used in their non-limiting sense to mean that items following the word are included, but items not specifically mentioned are not excluded.

In addition, reference to an element by the indefinite article “a” or “an” does not exclude the possibility that more than one of the element is present, unless the context clearly requires that there is one and only one of the elements. The indefinite article “a” or “an” thus usually means “at least one”.

The mechanism in process according to the invention is as follows. In the CO₂-absorption step, the amine absorbs CO₂. The CO₂-containing amine has a higher solubility in water than the amine before it has absorbed CO₂. Therefore, at the end of the absorption step, the reaction mixture is a single-phase system, wherein the single phase is an aqueous phase comprising water, solute salt, and CO₂-containing amine (and optionally some amine which has not absorbed CO₂).

When the temperature increases, CO₂ is desorbed from the amine. The amine from which CO₂ has been desorbed has a lower solubility in water. Also, the amine solubility decreases with increasing temperature. Both effects result in the formation of a two-phase system, bringing the system above its LCST.

Depending on the nature of the system, the formation of a two-phase system may occur earlier or later in the desorption step. In all cases at the end of the CO₂ desorption step a two-phase system will have been formed.

In one embodiment of the present invention, the two-phase system is formed early in the desorption step. In this case the two-phase system is subjected to phase separation, and at least part of the aqueous phase is subjected to CO2 desorption conditions. In this case, the non-aqueous phase, which contains amine (and generally small amounts of CO₂ and water) is processed separately. It is generally recycled directly to the absorption step.

It has been found that by using a thermoresponsive CO₂-absorbing agent comprising an amine-containing component, a solute inorganic salt, and water, an effective and efficient CO₂ removal process may be carried out. The system has been found to have a high net CO₂ sorption. Further, as compared to other systems, the desorption temperature may be relatively low. Additionally, it is possible to obtain relatively high amine concentrations. Further, as compared to salt-free systems, a broader range of amines can be used, which gives improved processing flexibility.

The CO₂ absorbing agent displays LCST behaviour. This means that below a certain temperature, i.e. the LCST (Lower Critical Solution Temperature), the amine containing component will be dissolved in the water phase (also containing the salt) forming a homogeneous solution. When the temperature of the CO₂-absorbing agent is increased to a value above the LCST, the solubility of the amine-containing component in the water phase will decrease, causing the amine containing component to form a separate phase. The total system will then contain an aqueous phase and a non-aqueous phase. Below the LCST, CO₂ will be generally absorbed by the amine-containing component in solution (depending on CO₂ pressure). Above the LCST, the amine-containing component will generally release CO₂. As will be evident to the person skilled in the art, the LCST of the CO₂ absorbing agent is dependent on the amount of CO₂ absorbed by the amine component.

The temperature in the absorption step should be such that the temperature of the CO₂ absorbing agent at the end of the absorption step is below the LCST of the CO₂-absorbing agent at the CO₂ loading at the end of the absorption step, resulting in absorption of CO₂.

The temperature at the end of the absorption should be below the LCST of the CO₂ absorbing agent at the end of the absorption step. This is to ensure that the absorption of (a substantial part, e.g., at least 20%, preferably at least 30%, in particular at least 40%, more in particular at least 50%, of) the CO₂ takes place when the amine component is dissolved. The CO₂ loading at the end of the absorption step is the amount of CO₂ that is absorbed by the CO₂ absorbing agent under the conditions prevailing during the absorption step. This value can be determined by absorption experiments.

The temperature in the desorption step should be such that the temperature at the end of the desorption step is above the LCST of the CO₂-absorbing agent at the CO₂ loading at the end of the desorption step, resulting in the desorption of CO₂. This is to ensure that the desorption of (a substantial part, e.g., at least 20%, preferably at least 30%, in particular at least 40%, more in particular at least 50%, of) the CO₂ takes place when the CO₂ absorbing agent has gone through its LCST point.

The CO₂ loading at the end of the desorption step is the amount of CO₂ that will remain on the amine-containing component under the conditions prevailing during the desorption step. This value can be determined by absorption/desorption experiments.

As indicated above, the CO₂-absorbing agent comprises water, an amine-containing component, and a solute inorganic salt.

In one embodiment, the CO₂-absorbing agent has a (solute) inorganic salt concentration in the range of 0.01-10 mole/liter, preferably in the range of 0.1-6 mole/liter. In one embodiment, the salt concentration is in the range of preferably in the range of 1-6 mole/liter. In another embodiment it preferably is in the range of 0.2-1 mole/liter. The nature of the salt will be discussed in more detail below.

In one embodiment, the amine-containing component is present in the CO₂-absorbing agent in an amount of 0.1-90 wt. %, in particular 1-50 wt. %, more in particular 10-40 wt. %. The nature of the amine-containing component will be discussed in more detail below.

In one embodiment, the CO₂-absorbing agent has a water content in the range of 1-99 wt. %, in particular in the range of 10-80 wt. %, more in particular in the range of 30-70 wt. %.

The presence of solute salt in the CO₂ absorbing agent leads to an increase of the net CO₂ sorption. The inorganic salt used in the present invention preferably has a solubility in water of at least 0.01 mole/liter (determined at 20° C.). If the solubility is too low, it will not be possible to obtain concentrations effective for obtaining the advantageous effect of the present invention.

The cation of the salt may, e.g., be selected from the group of monovalent cations, including sodium, potassium, lithium and ammonium, divalent cations such as calcium, magnesium, and barium, and trivalent cations such as aluminium. The use of monovalent and divalent cations is preferred, with the use of monovalent cations being particularly preferred. Sodium, potassium, and lithium are considered particularly preferred.

The anion of the salt may be a monovalent anion, such as a halogen anion, e.g., chloride, bromide, iodide, or fluoride, or other monovalent anion, such as nitrate. The anion may also be a divalent anion such as sulfate, or a trivalent anion such as phosphate. Monovalent and divalent anions are considered preferred at this point in time, with divalent anions being considered particularly preferred.

The salts based on monovalent cations and divalent anions are considered more preferred than salts based on monovalent cations and monovalent anions, which are in turn more preferred than other salts.

Examples of suitable salts include: sodium chloride, calcium chloride, potassium chloride, lithium chloride, barium chloride, calcium nitrate, sodium nitrate, potassium nitrate, lithium nitrate, sodium sulfate, potassium sulfate, lithium sulfate, calcium sulfate, aluminium chloride, aluminium nitrate, ammonium chloride, ammonium nitrate, and ammonium sulfate. The following salts are considered preferred at this point in time: sodium sulfate, potassium sulfate, sodium chloride, potassium chloride and potassium chloride, sodium nitrate and potassium nitrate. Sodium sulfate and potassium sulfate are considered particularly preferred.

The CO₂-absorbing agent used in the process according to the invention generally has an LCST in the range of 1-99° C., more preferably in the range of 10-80° C., still more preferably in the range of 20-70° C. The LCST of the CO₂-absorbing agent depends on a number of factors, including the nature of the amine-containing component, the pH of the aqueous medium, the concentration of the amine-containing component in the aqueous medium, the concentration and nature of solute salt in the aqueous medium, the CO₂ loading, and the further composition of the aqueous medium.

The LCST of the CO₂ absorbing agent can be determined by means of DSC (differential scanning calorimetry), wherein, upon heating the CO₂ absorbing agent from the temperature at the end of the absorption step to the temperature at the end of the desorption step, the LCST is the abscissa temperature at the maximum of the endothermic peak.

The CO₂ absorbing agent may contain a single type of amine-containing component. However, the use of mixtures of different types of amine-containing components is also envisaged in the present invention.

The amine-containing component will be described in more detail below, by way of various properties and parameters. It will be clear to the skilled person that these properties and parameters can be combined at will.

In one embodiment, the amine-containing component has a boiling point of at least 100° C. The reason for this preference is to ensure that the amine-containing component is not evaporated from the system to a substantial extent during the CO₂ desorption step, which may take place at elevated temperature. It may be preferred for the boiling point to be even higher, e.g., at least 130° C., in particular at least 160° C.

To allow for an effective absorption step, in one embodiment, the amine-containing component has a solubility in the CO₂ absorbing agent at the absorption temperature of between 0.5 and 5 mole/liter. Preferred ranges include a solubility in the CO₂ absorbing agent of between 1.5. and 4.5 mole/liter.

In one embodiment the amine-containing component is at least one an organic compound with 2-20 carbon atoms, more in particular 4-12 carbon atoms, comprising one or more amine groups. It should be noted that due to the presence of the salt it is possible in the present invention to use amine components with a relatively high amine/carbon ratio. This is advantageous because it increases the amount of amine groups per gram of amine-containing component.

Suitable amines in this context include heptylamine, 2-aminoheptane, (2-methylcyclohexyl)amine, 1-octylamine, 1-amino-2-ethylhexane, 1,5-dimethylhexylamine, 3,3,5-trimethylcyclohexylamine, 1-decylamine, dipropylamine (DPA), ethylbutylamine (EBA), diallylamine (DAA), N-ethyl-2-methylallylamine (EMAA), N-methylcyclohexylamine (MCA), dibutylamine, di-sec-butylamine (DsBA), di-iso-butylamine (DiBA), N-ethyl-cyclohexylamine, N-isopropylcyclohexylamine, dipentylamine, N,N-dimethyloctylamine, dihexylamine, N,N-diisopropylethylamine (DPEA), N,N-dimethylcyclohexylamine (DMCA), triallylamine, tripropylamine, N,N-diethylcyclohexamine, N,N,N,N, -tetramethyl-1,6-hexanedi amine, N-methyldiethanolamine (MDEA), piperazine, diglycolamine, diethanolamine, diisopropylamine, tributylamine triisobutylamine, 1,5-pentanediamine, 1,6-hexanediamine, 1,7-heptanediamine, and 2-aminoethanol (MEA), and their skeletal and regioisomers where applicable. Most preferred are 2-aminoethanol, N-methylcyclohexylamine, N-methyldiethanolamine, hexylamine, N,N-dimethylcyclohexylamine. For further suitable amine-containing components reference may be made to US2010/288126, incorporated by reference.

Skeletal isomers are compounds wherein the carbon skeleton is reordered. For example, skeletal isomers of n-pentylamine (or 1-pentylamine or pentan-1-amine) include 1,1-dimethylpropylamine (or 2-methylbutan-2-amine).

Regioisomers are compounds wherein the functional substituent (here an amino group) is attached to a different atom of the carbon skeleton. For example, regioisomers of n-pentylamine include 2-aminopentane (or pentan-2-amine).

In one embodiment of the present invention, the CO₂-absorbing agent comprises as amine-containing component a thermoresponsive copolymer comprising amine monomers. Within this embodiment it may be preferred for the thermoresponsive copolymer to comprise amine monomers and LCST monomers. The amine monomers are primarily responsible for CO₂ absorption in the final polymer; the LCST monomers are primarily responsible for the LCST effect in the final polymer.

For the avoidance of doubt, the LCST monomers, also indicated as thermoresponsive monomers, will not show thermoresponsive behaviour in the monomer form. Neither do homopolymers of these monomers necessarily show thermoresponsive behaviour. Within the context of the present specification the term thermoresponsive monomer or LCST monomer intends to refer to the monomer primarily responsible for the thermoresponsive behaviour, in contrast with the amine monomer, which is primarily responsible for the CO₂ absorption behaviour. In general the LCST monomer has a higher hydrophobicity than the amine monomer. In general the LCST monomer has a lower solubility than the amine monomer. It is noted that, as is evident to the skilled person, the polymer strictly speaking does not contain monomer molecules, but contains monomeric units derived from monomer molecules. For ease of reference both are indicated as monomers in the present specification.

The amine monomer content in the thermoresponsive copolymer generally is in the range of 0.1-99 mol %, preferably in the range of 1-70 mol %, more preferably in the range of 10-50 mol %.

The amine monomer may be any polymerisable monomer containing at least one primary, secondary or tertiary amine functional group. Tertiary amines are most preferred, with secondary amines being less preferred, and primary amines being still less preferred.

The amine preferably has in the range of 2 to 20 carbon atoms, more preferably in the range of 5 to 12 carbon atoms.

Preferably, the amine monomer is selected from the group of amine functionalized acrylamides, amine functionalized methacrylamides, amine functionalized acrylates, amine functionalized methacrylates, and cyclic amine monomers. More preferably, the amine monomer is selected from the group of dim ethyl aminopropyl acrylamide (DMAPAM), dim ethyl aminoethyl methacrylate, diethylallyl amine, dimethylaminopropyl methacrylate, dimethylamino propyl methacrylamide, diethylaminoethyl methacrylate, diethylamino ethyl acrylamide, diethylamino propyl acrylamide, diethylamino ethyl methacrylamide, diethylamino propyl acrylamide, dimethylamino ethyl acrylamide, dimethylaminopropyl acrylate, diethylaminopropyl methacrylate, diethylaminopropyl acrylate, diethylaminoethyl acrylate, 2-(di ethyl amino)ethyl styrene, 2-(N,N-dimethylamino)ethyl acrylate, 2-(tert-butylamino)ethyl methacrylate, 2-Diisopropylaminoethyl methacrylate, 2-N-morpholinoethyl acrylate, 2-N-morpholinoethyl methacrylate, 3-dimethylaminoneopentyl acrylate, N-(tent-BOC-aminopropyl)methacrylamide, N-[2-(N,N-dimethylamino)ethyl]methacrylamide,. Most preferably the amine monomer is selected from the group of DMAPAM, dimethylaminoethyl methacrylate, diethylallyl amine, dimethylaminopropyl methacrylate, dimethylamino propyl methacrylamide, diethylaminoethyl methacrylate, diethylaminopropyl acrylate. It is possible to use a single type of amine, but combinations of two or more amines may also be used.

The LCST monomer may be a monomer that polymerized as a homopolymer exhibits an LCST in the aqueous solution. Such monomer could be selected from the group of acrylamides, acrylates, vinylamides, alkyloxazolines, vinylimidazoles, and vinylethers. The use of acrylamides may be preferred. The LCST monomer generally has 2-20 carbon atoms, preferably 5-12 carbon atoms.

The LCST monomer may also be a monomer that when polymerized as a homopolymer has no LCST in the aqueous solution, but when copolymerized with the amine monomer exhibits a LCST in the aqueous solution. In this case the LCST monomer provides the proper hydrophilic/hydrophobic balance to ensure that the copolymer obtains the proper thermoresponsive behavior. It is noted that LCST behavior of polymers is known in the art, and that it is well within the scope of the skilled person to select a suitable LCST-monomer. Preferably the LCST monomer is selected from the group of N-isopropylacrylamide, N-vinylcaprolactam, N-isopropyloxazoline, ethyloxazoline, N-propyloxazoline, N-vinylimidazole, N-acryloyl-pyrrolidin, diethylacrylamide, N-propylacrylamide, N-pentamethyleneacrylamide, methylethylacrylamide, N-ethylacrylamide, N-propylmethacrylamide, N-isopropylmethacrylamide, acryloyl morpholine, cyclopropylmethacrylamide, hydroxypropylcellulose, propylene glycol, ethyleneglycol, diethyleneglycolacrylate, poly(ethyleneglycol)acrylate, N-tetrahydrofurfurylacrylamide, N-tetrahydrofurfuryl ethacrylamide, and poly(ethyleneglycol)methacrylate. It is possible to use a single type of LCST monomer, but combinations of two or more LCST monomers may also be used. The use of a single LCST monomer may sometimes be preferred to prevent unintentional interaction between the two types of monomers.

In one embodiment of the present invention, the LCST monomer has relatively low molecular weight, to reduce overall polymer mass. It may therefore be preferred for the molecular weight of the monomer to be below 200 g/mole, in particular in the 25 range of 100-150 g/mole.

The thermoresponsive copolymer used in one embodiment of the present invention generally has a weight average molecular weight M_{w} of at least 500 g/mole. If the molecular weight of the polymer is below this value LCST behaviour is difficult to obtain. Preferably, the copolymer has a M_{w} of at least 10.000 g/mole. A maximum for the molecular weight is not critical, as a general value, maximum of at most 2.000.000 may be mentioned.

In one embodiment of the process according to the invention a polymer is used which is a copolymer comprising amine monomer distributed through the copolymer. Within the context of the present specification this means that the amine monomers are distributed in such a fashion that at least 80% of the amine monomers in the polymer are present in arrays of maximum 10 amine monomers, which are combined with arrays of thermoresponsive monomers, with each polymer molecule comprising at least 2 areas of both monomer types. This is in contrast with block copolymers, wherein a block of a first type of monomer is connected to a block of a second type of monomer, resulting in a polymer of the formula AAA(..)AAA-BBB(...)BBB. It has been found that, as compared to the use of a block copolymer, a copolymer of the same monomers wherein the amine monomers are distributed through the polymer results in a higher αₙₑₜ. Not wishing to be bound by theory, it is believed that this is caused by the fact that in random copolymers the influence of the thermosensitive part of the polymer on the CO₂ absorption properties is increased. Suitable polymers include those described in WO 2014/140108, incorporated by reference.

In the following, the various steps of the process according to the invention are described in more detail.

The first step in the process according to the invention is contacting a CO₂-containing gas stream with the CO₂-absorbing agent described above in an absorption step, wherein the temperature of the CO₂ absorbing agent at the end of the absorption step is below the LCST of the CO₂-absorbing agent at the CO₂ loading at the end of the absorption step, resulting in absorption of CO₂.

The nature of the CO₂-containing gas stream is not critical to the process according to the invention. The gas stream may be derived, e.g., from a power plant or other chemical reactor. The CO₂ content of the gas stream may vary between wide ranges.

In one embodiment, the CO₂-content is in the range of 1 to 20 vol. %, calculated on the total volume of the gas stream, in particular 4 to 12 vol. %. The gas stream may contain further components such as nitrogen and oxygen.

It is preferred for the CO₂-containing gas stream to be substantially free of NOₓ and SOₓ compounds, because they irreversibly bind to the amine. These compounds, if present at all, are preferably present in an amount of less than 100 ppm, more preferably less than 10 ppm, most preferably less than 1 ppm.

The gas stream is contacted with the CO₂ absorbing agent in a vessel in a manner which ensures intimate contact between the CO₂ in the gas and the liquid CO₂ absorbing agent. This can be done in manners known in the art, e.g., using an absorption column. The gas stream may be contacted with the CO₂ absorbing agent in cocurrent or countercurrent operation, with countercurrent operation being preferred.

As indicated above, the temperature at the end of the absorption step is below the LCST of the CO₂ absorbing agent at the CO₂ loading at the end of the absorption step in the reaction medium. In general, this temperature lies in the range of 0-90° C., more preferably in the range of 5-60° C., still more preferably in the range of 20-50° C. In one embodiment it may be preferred for the temperature at the end of the absorption step to be at least 5° C. below the LCST, preferably below 10° C.

The temperature of the gas as it is contacted with the CO₂ absorbing agent is not critical, as long as the temperature of the CO₂ absorbing agent stays in the range stipulated above.

The pressure in the process according to the invention is not critical. In one embodiment the process according to the invention is carried out at a pressure of 1-10 bar, e.g., in the range of 1-5 bar, more specifically in the range of 1-1.1 bar.

This step yields a CO₂ containing CO₂ absorbing agent, and a CO₂-lean gas stream.

In one embodiment, the CO₂-lean gas stream has a CO₂ content which is at most 20% of the CO₂ content of the starting CO₂-containing gas stream, in particular at most 10%.

In the next step of the process according to the invention the temperature of the CO₂-absorbing agent is increased. Preferably the CO₂ absorbing agent is brought into a second vessel, which is preferably a distillation column or spray tower, but could be any vessel. The temperature at the end of the desorption step is above the LCST of the CO₂-absorbing agent at the CO₂ loading at the end of the desorption step. Depending on process operation, the temperature at the inlet of the desorption step may be higher that the temperature at the outlet of the desoption step.

In general, the temperature at the end of the desorption step lies in the range of 40-100° C., preferably in the range of 40-90° C., more preferably in the range of 40-80° C. It may be preferred for this temperature to be at least 10° C. above the LCST, more preferably at least 30° C.

The second column is operated at a pressure of 0.1-10 bar, preferably at a pressure of 1-3 bar. CO₂ desorption can be enhanced by using ultrasound, nucleation by solid particles or stirring.

As indicated above, during the desorption step a two-phase system will be formed. Depending on the nature of the system, the formation of a two-phase system may occur earlier or later in the desorption step.

In one embodiment, the entire combination of aqueous phase and non-aqueous phase is subjected to a CO₂ desorption step. In another embodiment of the present invention, the two-phase system formed during the desorption step is subjected to phase separation, resulting in a stream comprising mainly (at least 70 wt. %, preferably at least 80 wt. %, more preferably at least 90 wt. %) non-aqueous phase and a stream comprising mainly (at least 70 wt. %, preferably at least 80 wt. %, more preferably at least 90 wt. %) aqueous phase after which the stream comprising mainly aqueous phase is subjected to a CO₂ desorption step, resulting in the release of CO₂. In this case, the non-aqueous phase is processed separately. In one embodiment it is recycled directly to the absorption step.

The CO₂ desorption step leads to the formation of a CO₂-containing gas stream, and a CO₂-absorbing agent from which CO₂ has been desorbed. The CO₂-containing gas stream generally consist for at least 80 vol. % of CO₂, more preferably for at least 95 vol. %, still more preferably for at least 99 vol. %. Additionally the CO₂-containing gas stream resulting from the desorption step generally comprises water resulting from the CO₂-absorbing agent. Water may, e.g., be present in an amount of 0 to 10 vol. %, preferably 0 to 1 vol. %. The CO₂ released may be processed as desired. It can. e.g., be subsequently compressed to 20-100 bar. Water in the recovered CO₂-containing gas stream can be removed by condensation, resulting in the high CO₂ concentrations mentioned above.

The CO₂-absorbing agent as it results from the desorption step is generally recycled to the CO₂ absorption step after it has been cooled down. In the case that a phase separation is carried out and the stream comprising mainly the aqueous phase is subjected to the CO₂ desorption step, the resulting aqueous phase from which CO₂ has been desorbed will be combined with the non-aqueous phase before being recycled to the CO₂ absorption step.

In one embodiment it may be preferred for the range for α_{absorption} to be 0.4-1.0. Preferably the range for α_{absorption} is 0.7-0.9 for CO₂ absorbing agents containing solely tertiary amine groups. For CO₂ absorbing agents containing solely primary and secondary amine groups it may be preferred for the range for α_{absorption} to be 0.2-0.5, preferably the range for α_{absorption} is 0.35-0.5. For CO₂ absorbing agents containing a combination of tertiary and primary or secondary amine groups the range of α_{absorption} is preferred to be the weighted average of the α_{absorption} of the tertiary amine part and the α_{absorption} of the primary/secondary amine part.

In one embodiment it may be preferred for the range for α_{desorption} to be 0-0.4. Preferably the range for α_{desorption} is 0-0.3, most preferably the range is 0.0-0.2 for CO₂ absorbing agents containing solely tertiary amine groups. For CO₂ absorbing agents containing solely primary and secondary amine groups it may be preferred for the range for α_{desorption} to be 0-0.2, preferably the range for α_{desorption} is 0-0.15. For CO₂ absorbing agents containing a combination of tertiary and primary or secondary amine groups the range of α_{desorption} is preferred to be the weighted average of the α_{desorption} of the tertiary amine part and the α_{desorption} of the primary/secondary amine part.

An important feature of the process according to the invention is that a high net

CO₂ sorption may be obtained. For example, the net CO2 sorption in the process according to the invention may be at least 0.3, in particular at least 0.4, in some embodiments at least 0.5. In one embodiment, the net CO2 sorption in the process according to the invention over the temperature range of 25° C. (absorption temperature) to 75° C. (desorption temperature) is at least 0.3, more in particular at least 0.5. In another embodiment, the net CO₂ sorption in the process according to the invention over the temperature range of 50° C. (absorption temperature) to 75° C. (desorption temperature) is at least 0.2, more in particular at least 0.3. In a further embodiment, the net CO₂ sorption in the process according to the invention over the temperature range of 40° C. (absorption temperature) to 80° C. (desorption temperature) is at least 0.25, more in particular at least 0.4.

In one embodiment of the process according to the invention, the difference between the temperature at the end of the desorption step and the temperature at the beginning of the absorption step lies in the range 5-100° C., more preferably the difference lies in the range of 5-70° C., still preferably the difference lies in the range of 20-50° C.

The process according to the invention can be carried out in batch operation, where the aforementioned steps are occurring at different times. However, preferably the process is carried out in continuous mode where the aforementioned steps are occurring at different locations simultaneously.

In one embodiment, the process according to the invention is carried out in a swing mode, wherein the CO₂ absorbing agent is present in a reaction vessel, wherein in a first step a CO₂-containing gas stream is provided to the vessel, and the vessel is kept at a temperature resulting in absorption of CO₂. Then, the flow of CO₂-containing gas stream is stopped, and the temperature of the vessel is increased to a value where CO₂ is desorbed, and the resulting CO₂ is withdrawn from the vessel.

In another embodiment, the process according to the invention is carried out using separate vessels for the absorption step and the desorption step. In this embodiment, the process comprises the steps of contacting a CO₂-containing gas stream with a CO₂-absorbing agent in an absorption column at the temperature discussed above resulting in absorption of CO₂, and leading the CO₂ containing absorbing agent to a second column with a temperature discussed above resulting in the release of CO₂. This process is a preferred embodiment of the process according to the invention.

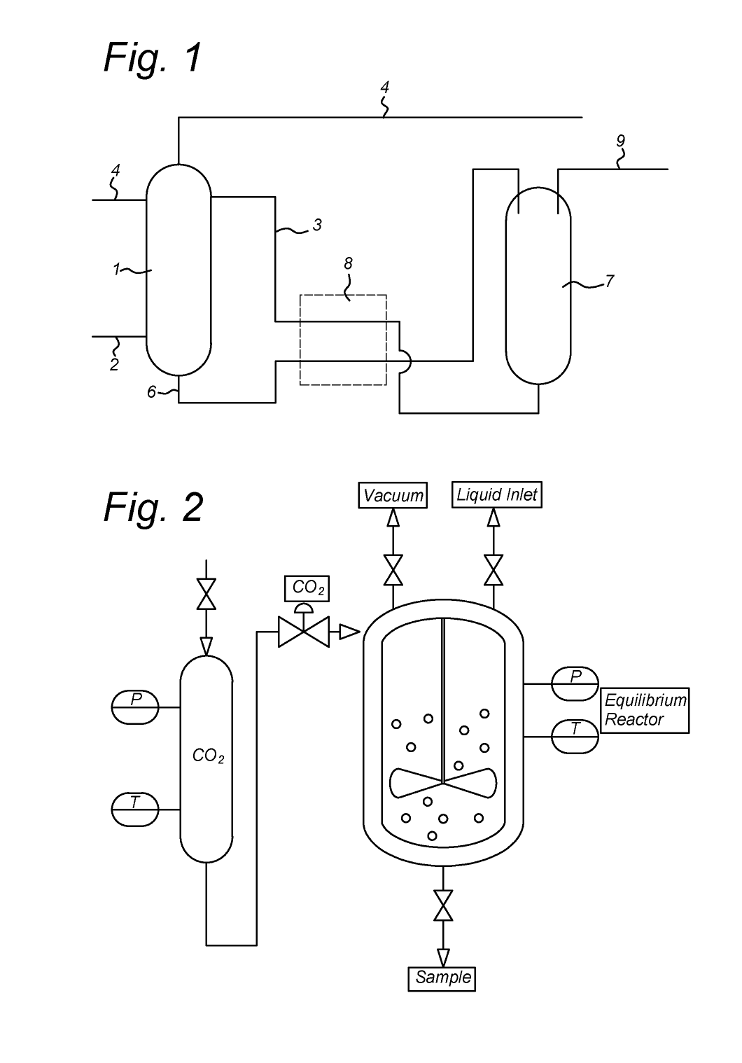

One embodiment of this process is illustrated in FIG. 1. In FIG. 1, a CO₂-containing gas stream (2) is provided to the bottom of an absorption column (1), with a maximum temperature specified above. The CO² absorbing agent is provided to the top of the column through line (3), ensuring countercurrent operation. CO₂ is absorbed from the CO₂-containing gas stream. If so desired make-up liquid may be added to the process through line (4). Make-up liquid may comprise water and amine to make up for evaporation losses, and salt to make up for losses in the process. A gas stream from which CO₂ has been removed is withdrawn from the column through line (5). The CO₂ absorbing agent which has absorbed CO₂ is withdrawn from the bottom of the column through line (6), and provided to the top of a desorption column (7), after having passed through a heat exchanger (8), where the temperature is increased. Desorption column (7) has a temperature which is such that there is release of the CO₂ from the CO₂ absorbing agent. A CO₂-containing gas stream is withdrawn from the desorption reactor through line (9). The CO₂-containing gas stream generally also contains water. Therefore, in one embodiment, the CO₂-containing gas stream may be provided to a step (not shown) wherein to CO₂ and water are separated. The CO₂ absorbing agent is removed from desorption column (7) through a line (3) at the bottom of the unit, which line (3) passes through heat exchanger (8), and recycles the CO₂ absorbing agent to absorption reactor (1).

The present invention will be elucidated by the following example, without being limited thereto or thereby.

### EXAMPLES

### Example 1

### Experimental Setup

For the experiments a stainless steel, high pressure and temperature reactor (HP) and a glass reactor (GR) with a larger volume was used. Both set-ups contain a gas storage vessel (500 ml; T and P are monitored), which is connected to the reactor (T and P monitored). The reactor contains a gas-inducing impeller (up to 10,000 rpm). Liquid enters the reactor at the liquid inlet, which can be closed hermetical afterwards. The vacuum pump is connected to both the reactor and the gas storage vessel independently. FIG. 2 shows a schematic representation of the reactors. The pressure indicators (0-10 bar for the storage vessel) and 0-2 bar for the reactor have a typical inaccuracy of 0.1% Full Scale (which means that the mentioned inaccuracy holds for the whole pressure range).

### Procedure

The vessel was filled with 100 ml of CO₂ absorbing agent with a known amount of amines and degassed several times. Next the vessel was brought to the desired temperature. A gas mixture of CO₂ and nitrogen of 1 bar total pressure (P_{CO2}=100 mbar) was led into the reactor. The temperature and pressure inside both the reactor and the gas storage vessel were monitored. From the monitored CO₂ flow into the reactor the alpha values were calculated.

### Composition of CO₂ Absorbing Agent

The following CO₂ absorbing agents were used in the experiments: DMCA/MCA water mixtures with respectively no salt, NaCl and Na₂SO₄. See Table 1.

TABLE 1

| | | | | | | | Concen- |
|---|---|---|---|---|---|---|---|
| | | | | Wa- | | | tration |
| | MCA | DMCA | Salt | ter | Total | Total | amine |
| Experiments | (g/L) | (g/L) | (g/L) | (g/L) | (g) | (ml) | (mol/L) |
| DMCA/MCA | 255.2 | 95.3 | — | 597.3 | 495.4 | 522.7 | 3.00 |
| 40° C. | | | | | | | |
| DMCA/MCA | 254.8 | 95.4 | — | 597.8 | 94.9 | 100.1 | 3.00 |
| 80° C. | | | | | | | |
| DMCA/MCA + | 255.0 | 95.5 | 43.5 | 553.8 | 381.4 | 402.4 | 3.00 |
| NaCl 40° C. | | | | | | | |
| DMCA/MCA + | 255.0 | 96.6 | 43.6 | 554.1 | 94.9 | 100.0 | 3.01 |
| NaCl 80° C. | | | | | | | |
| DMCA/MCA + | 254.8 | 94.8 | 120.0 | 596.9 | 106.8 | 100.1 | 3.00 |
| Na₂SO₄ 80° C. | | | | | | | |

### Results

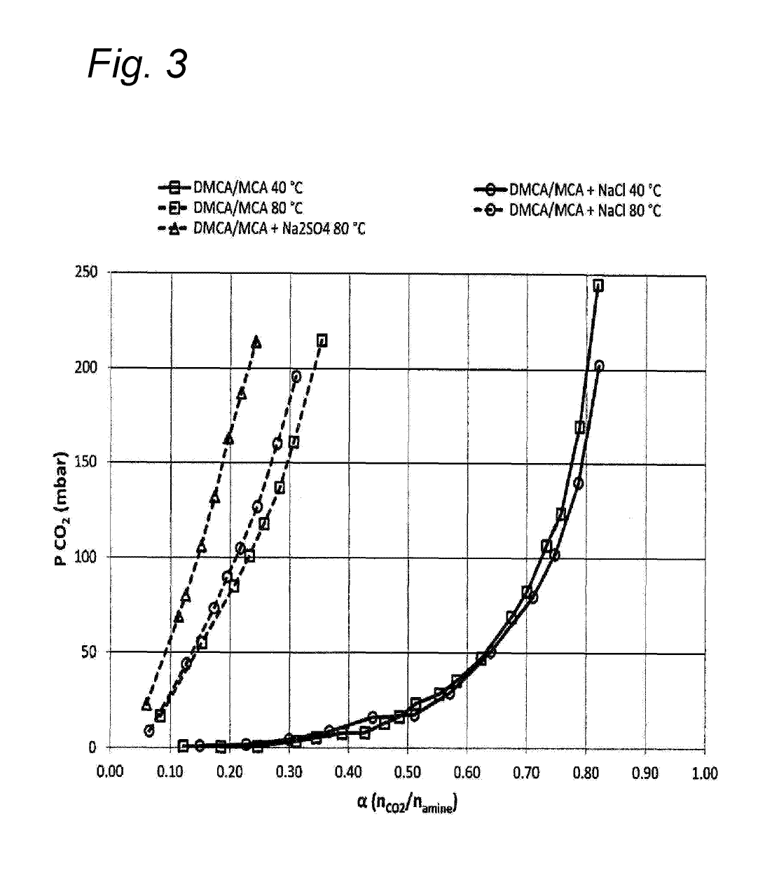

In FIG. 3 vapour/liquid equilibrium data are shown for CO₂ in equilibrium with 3 different CO₂ absorbing agents at temperatures of 40 and 80° C. and 1 bar pressure. At the absorption temperature of 40° C., a slightly higher α_{absorption}, i.e. higher CO₂ loading, can be observed for the NaCl system as compared to the salt free system, whereas at the desorption temperature of 80° C. a slightly lower αdesorption can be found, i.e. lower loading for the NaCl containing agent. Clearly, the addition of NaCl has a positive effect on the αₙₑₜ. Furthermore, the addition of Na₂SO₄ leads to an even larger decrease of α_{desorption}.

1.-24. (canceled)

25. A process for capturing CO₂ from a CO₂-containing gas stream, comprising:
(a) contacting a CO₂-containing gas stream with a CO₂-absorbing agent in an absorption step wherein the temperature of the CO₂ absorbing agent at the end of the absorption step is below the Lower Critical Solution Temperature (LCST) of the CO₂-absorbing agent at the end of the absorption step, resulting in absorption of CO₂;
(b) increasing the temperature of the CO₂-absorbing agent, wherein the temperature at the end of the desorption step is above the LCST of the CO₂-absorbing agent at the end of the desorption step, resulting in the desorption of CO₂;
wherein the CO₂-absorbing agent is a thermoresponsive CO₂-absorbing agent comprising an amine-containing component, a solute inorganic salt, and water, and wherein the amine-containing component has a boiling point of at least 100° C. and the solute inorganic salt has a solubility in water of at least 0.01 mole/liter (determined at 20° C.).

26. The process according to claim 25 wherein the CO₂-absorbing agent has a solute inorganic salt concentration in the range of 0.01-10 mole/liter.

27. The process according to claim 26, wherein the range is 0.1-6 mole/liter.

28. The process according to claim 27, wherein the range is 1-6 mole/liter.

29. The process according to claim 25, wherein the amine-containing component is present in the CO₂-absorbing agent in an amount of 0.1 -90 wt. %.

30. The process according to claim 29, wherein the amine-containing component is present in an amount of 1-50 wt. %.

31. The process according to claim 30, wherein the amine-containing component is present in an amount of 10-40 wt. %.

32. The process according to claim 25, wherein the salt in the CO₂-absorbing agent is based on monovalent cations and divalent anions.

33. The process according to claim 32, wherein the salt is selected from the group consisting of sodium sulfate and potassium sulfate.

34. The process according to claim 25, wherein the amine-containing component is at least one organic compound with 2-20 carbon atoms, comprising one or more amine groups.

35. The process according to claim 34, wherein the amine-containing component is at least one organic compound with 4-12 carbon atoms.

36. The process according to claim 25, wherein the CO₂-absorbing agent has an LCST in the range of 1-99° C.

37. The process according to claim 36, wherein the CO₂-absorbing agent has an LCST in the range of 10-80° C.

38. The process according to claim 37, wherein the CO₂-absorbing agent has an LCST in the range of 20-70° C.

39. The process according to claim 25, wherein the CO₂-content of the CO₂-containing gas stream is in the range of 1 to 20 vol. %, calculated on the total volume of the gas stream.

40. The process according to claim 39, wherein the CO₂-content is 4 to 12 vol. %.

41. The process according to claim 25, wherein the temperature at the end of the absorption step is in the range of 0-90° C.

42. The process according to claim 41, wherein the temperature is in the range of 5-60° C.

43. The process according to claim 42, wherein the temperature is in the range of 20-50° C.

44. The process according to claim 25, wherein the temperature at the end of the desorption step is in the range of 40-100° C.

45. The process according to claim 44, wherein the temperature is in the range of 40-90° C.

46. The process according to claim 45, wherein the temperature is in the range of 40-80° C.

47. The process according to claim 25, wherein a two-phase system is formed during the desorption step, which system is subjected to phase separation, resulting in a stream comprising mainly of non-aqueous phase and a stream comprising mainly aqueous phase after which the stream comprising mainly aqueous phase is subjected to a CO₂ desorption step, resulting in the release of CO₂.

48. The process according to claim 47, wherein the non-aqueous phase generated in the phase separation step is recycled directly to the absorption step.
